(19) United States
(12) Patent Application Publication
(10) Pub. No.: US 2003/0029167 A1
(43) Pub. Date: Feb. 13, 2003

(54) Motor vehicle cooling system

(75) Inventors: Scott A. Hudson, Cedar Falls, IA (US); Hartmut Bobertag, Altrip (DE); Waldemar Stark, Frankenthal (DE)

Correspondence Address: Joel S. Carter, Patent Department, DEERE & COMPANY, One John Deere Place, Moline, IL, 61265-8098, US

(73) Assignee: Deere & Company, a Delaware corporation

(21) Appl. No.: 10/144,508

(22) Filed: May 13, 2002

(30) Foreign Application Priority Data
Aug. 9, 2001 (DE) 101 39 314.8

(51) Int. Cl. F02B 33/00; F02B 33/44; F02B 29/04

(52) U.S. Cl. 60/598; 60/599; 123/559.1

(57) ABSTRACT

A cooling system for a motor vehicle includes an engine cooling circuit in which an engine cooling circuit coolant pump pumps the coolant through at least one engine cooling system and an engine cooling circuit heat exchanger. The cooling system also includes a separate supercharger air cooling circuit in which a supercharger air cooling circuit coolant pump pumps the coolant through at least one supercharger air cooler and a supercharger air cooling circuit heat exchanger. The two cooling circuits are connected with a common expansion tank via ventilation lines which connect each cooling circuit with an upper portion of the expansion tank.

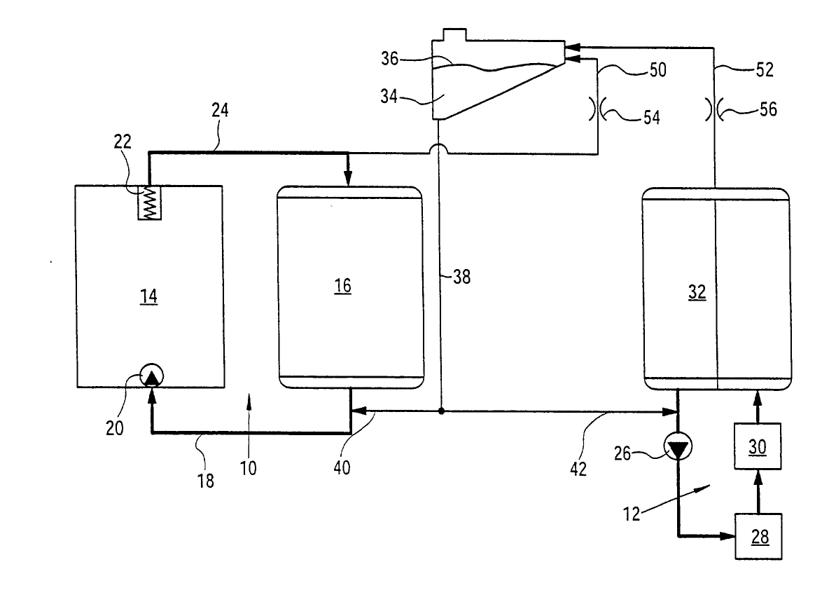

### FIELD OF THE INVENTION

This invention relates to a motor vehicle cooling system with an engine cooling circuit, a supercharger air cooling circuit and a common fluid reservoir.

### BACKGROUND OF THE INVENTION

DE 199 56 893 A1 shows a cooling circuit for an internal combustion engine, wherein a coolant pump pumps a coolant in a circuit that includes primarily the engine, a thermostatic valve and a main heat exchanger. An engine drain line is connected via a first ventilation line with an equalizing reservoir that compensates for thermal expansion effects of the coolant as well as minor leakages. Furthermore, second and third ventilation lines connect other locations in the cooling circuit with the equalization reservoir, each line including a throttle. A filler line connects the bottom of the equalization reservoir to an engine supply line. DE 199 56 893 A1 does not mention a supercharger air cooling circuit.

As long as several separate cooling circuits are provided, several equalization reservoirs are normally associated with the cooling circuits, in order to be able to keep the cooling circuits separate from each other. However, this requires several separate filler locations for the filling and topping off the coolant, which necessitates an added cost for the filling and the current control of the coolant level in the cooling circuits.

Such a cooling system with two separate cooling circuits is described in U.S. Pat. No. 5,598,705. Each cooling circuit is fully functional and operates independently so that mixing of the coolant of the two circuits can be avoided, and a lower temperature can be maintained in the supercharger air cooling circuit than in the engine cooling circuit. The two cooling circuits are connected to a common coolant reservoir, in order to equalize flow between the two circuits. Valves are arranged in connecting lines between the two circuits. By opening the valve the coolant flows in the two circuits can be mixed with each other in order to avoid excessively high temperatures in the engine cooling circuit or to prevent freezing of the coolant in the supercharger air cooling circuit.

### SUMMARY OF THE INVENTION

An object of the invention is to provide a cooling system wherein a single equalization reservoir and filler location serves two separate cooling circuits.

This and other objects are achieved by the present invention wherein a cooling system includes two separate cooling circuits. An engine cooling circuit includes an engine cooling circuit coolant pump which pumps coolant through an engine cooling system and an engine cooling circuit heat exchanger. A supercharger air cooling circuit includes a supercharger cooling circuit coolant pump which pumps coolant through a supercharger air cooler and a supercharger air cooling circuit heat exchanger. The two cooling circuits are connected to a common fluid reservoir or expansion tank. Ventilation lines connect each cooling circuit with the expansion tank in order to equalize pressure between the two cooling circuits.

With a single expansion tank pressure, heat expansion effects and minor leakages in and between the cooling circuits can be equalized. Only one filler location is required for topping off of the coolant, because the expansion tank has only a single filler opening that is usually closed by a closure cover.

The engine cooling circuit coolant pump is preferably driven mechanically by the engine, and is fastened directly to the engine cylinder block. In normal operation the coolant in the engine cooling circuit operates at a relatively high temperature so that the engine cooling circuit heat exchanger is designed preferably as a high temperature heat exchanger. On the other hand the temperature in the supercharger air cooling circuit is considerably lower, and the supercharger air cooling circuit heat exchanger is preferably designed as a low temperature heat exchanger.

The supercharger air cooler cools the combustion air for the internal combustion engine. In contrast to air cooled supercharger air coolers, coolant cooled supercharger air coolers are smaller and can be accommodated at nearly any desired place in the engine compartment.

The engine cooling circuit must have a cooling capacity which is generally considerably greater than that of the supercharger air cooling circuit. Therefore, the total flow in the engine cooling circuit is greater by a multiple (such as from 5 to 10 times) than the flow in the supercharger air cooling circuit.

Preferably, the flow or throughput in the ventilation lines is limited by throttling restrictions or orifices, so that only 1% to a maximum of 5% of the fluid flow circulating in the cooling circuits can enter the ventilation lines. This largely prevents an interchange of the cooling fluids between the two cooling circuits, so that despite the common expansion tank the two cooling circuits remain separate from each other, as far as the fluids are concerned.

Since the engine cooling circuit normally carries a greater throughput than the supercharger air cooling circuit, the engine cooling circuits develops more ventilation air flow than the supercharger air cooling circuit. Therefore, it is advantageous to design the ventilation lines of the engine cooling circuit for a greater throughput than the ventilation lines of the supercharger air cooling circuit. Thus, preferably, the flow through the ventilation lines leading to the supercharger air cooling circuit is throttled more heavily than the ventilation lines leading to the engine cooling circuit.

The heat exchanger in the supercharger air cooling circuit is preferably an air cooled low temperature heat exchanger with multiple paths and a plurality of series connected flow chambers. A long flow path provides a low output temperature with relatively small amounts of fluid. For example, the supercharger air cooling circuit heat exchanger cools the coolant in normal operation from approximately 93° C. to approximately 45° C. The heat exchanger is a so-called super-cooler. Normal heat exchangers provide a cooling of 5° C., whereas a super-cooler provides a cooling of up to 50° C.

Preferably, a pair of filler lines connect a lower fluid collection portion of the common expansion tank to the two cooling circuits so that the expansion tank can be used to supply coolant to both cooling circuits. The cooling circuits can be topped off with coolant in order to compensate for fluid losses due to leakage. The filler lines connect to a portion of the expansion tank which is below the fluid level.

Preferably, a gearbox oil cooler is integrated into the supercharger air cooling circuit. This oil cooler cools the gear oil of an automatic transmission or a shift gearbox shifted under load for a utility vehicle, for example, an agricultural tractor.

Preferably, the supercharger air cooling circuit coolant pump, the supercharger air cooler, a gearbox oil cooler, and the supercharger air cooling heat exchanger are arranged in series in the supercharger air cooling circuit. Preferably, the supercharger air coolant pump follows the heat exchanger so that the coolant flows through the pump after it has cooled, which is advantageous for the operation and durability of the coolant pump. The coolant flows directly from the pump to the supercharger air cooler, so that cooling performance of the supercharger air cooler can be optimized. Preferably, the pumps are electrically driven pumps which can be operated independent of the operation of the engine.

### BRIEF DESCRIPTION OF THE DRAWINGS

The sole FIGURE is a schematic diagram of a cooling system according to the present.

### DESCRIPTION OF THE PREFERRED EMBODIMENT

The engine cooling circuit 10 cools the engine cylinder block (not shown) and the cylinder heads (not shown) of an internal combustion engine 14, and includes an engine cooling circuit heat exchanger 16. The heat exchanger 16 is a conventional high temperature heat exchanger. Return line 18 supplies coolant cooled by the heat exchanger 16 to pump 20 which pumps coolant into the cooling system of the engine 14, in order to cool its engine cylinder block (not shown) and cylinder heads (not shown). A thermostatic valve 22 is located on the outlet side of the engine 14. When the thermostatic valve 22 is open the coolant flows from engine 14 through an inlet line 24 to the heat exchanger 16.

When the engine 14 is started, the engine cylinder block is normally cold and the thermostatic valve 22 is closed, so that the coolant is pumped by the coolant pump 20 in a small circuit through the engine 14 and a bypass line (not shown). Above 83 degrees centigrade (° C.) the thermostatic valve 22 starts to open, so that with increasing temperature an increasing amount of coolant flows through and is cooled by the heat exchanger 16. When approximately 90° C. is exceeded the bypass line closes completely, so that all the entire coolant is pumped through the heat exchanger 16.

A supercharger air cooling circuit 12 includes a supercharger air cooling circuit coolant pump 26, a supercharger air cooler 28, a gearbox oil cooler 30 and a supercharger air cooling circuit heat exchanger 32 arranged in a series circuit. Coolant pumped by pump 26 flows first through the supercharger air cooler 28, then through the gearbox oil cooler 30, and then through the supercharger air cooling circuit heat exchanger 32, and finally back to an inlet of the pump 26. The pump 26 is immediately downstream of the heat exchanger 32 and is thereby located at the coolest point of the supercharger air cooling circuit 12. The pump 26 is preferably driven electrically.

The supercharger air cooling circuit heat exchanger 32 is designed as a super cooler. It is located at a point in the supercharger air cooling circuit 12 at which the lowest pressure occurs. This is due to the fact that the flow resistance in the supercharger air cooler 28 and the gearbox oil cooler 30 reduces the pressure with respect to the output pressure of pump 26. Preferably, the supercharger air cooling circuit heat exchanger 32 is an air cooled low temperature heat exchanger with several paths.

The heat exchangers 16, 32 are preferably arranged in space behind each other and are cooled by a blower (not shown) which blows fresh air through the heat exchangers 16, 32. The two cooling circuits 10, 12 and coolant pumps 20, 26 are designed so that the coolant flow in the engine cooling circuit 10 is from five to ten times greater than the coolant flow in the supercharger air cooling circuit 12.

An expansion tank 34 is filled with coolant up to a fluid level 36. A filler line 38 extends from a lower portion tank 34 and branches into two lines 40 and 42. Line 40 is communicated with line 18 on the inlet side of pump 20. Line 42 is communicated with the inlet side of pump 26.

A pair of ventilation lines 50, 52 communicate with an upper portion of tank 34 at a level above the fluid level 36. At the point where they join the tank 34, lines 50, 52 may form a pair of concentric tubes (not shown) which operate as an ejector.

The first ventilation line 50 connects the expansion tank 34 with line 24. The second ventilation line 52 connects the expansion tank 34 with heat exchanger 32 and thereby to the supercharger air cooling circuit 12.

Each ventilation lines 50, 52 includes a corresponding throttling restriction 54, 56 through which the flow of a gas-fluid mixture is limited. The throttling restrictions 54, 56 are designed so that they permit a flow of only 1% to 5% of the fluid flow circulating in the associated cooling circuit. Since the fluid flow circulating in the supercharger air cooling circuit 12 is lower than the fluid flow circulating in the engine cooling circuit 10, the throttling restrictions 54, 56 in the two ventilation lines 50, 52 are correspondingly different. The flow in the ventilation line 52 leading to the supercharger air cooling circuit 12 is limited more heavily than the flow in the ventilation line 50 leading to the engine cooling circuit 10. For example, in ventilation lines 52 the throttle 56 has a circular cross section diameter of 3 mm, whereas throttle 54 has a circular cross section diameter of 6 mm.

Thus, the two cooling circuits 10, 12 are essentially separated from each other so that the fluid flows circulating in the two cooling circuits 10, 12 do not significantly influence each other. There is no significant mixing of the relatively warm fluid in the engine cooling circuit 10 with the relatively cool fluid in the supercharger air cooling circuit 12. This is because the filler line 38 and the ventilation lines 50, 52 do not permit any significant fluid flow interchange between the two cooling circuits 10, 12.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A cooling system for a motor vehicle having an engine, the cooling system having an engine cooling circuit with an engine coolant pump pumping coolant through the engine and an engine cooling circuit heat exchanger, the cooling system also having supercharger air cooling circuit which is substantially separate from the engine cooling circuit, the supercharger air cooling circuit having a supercharger air cooling circuit coolant pump which pumps coolant through a supercharger air cooler and a supercharger air cooling circuit heat exchanger, and the cooling system having a common fluid container connected to the engine cooling circuit and to the supercharger air cooling circuit, the improvement wherein:
the fluid container comprises an expansion tank;
a first ventilation line communicates the engine cooling circuit with an upper portion of the expansion tank; and
a second ventilation line communicates the supercharger air cooling circuit with an upper portion of the expansion tank.

2. The cooling system of claim 1, wherein:
coolant flow through the engine cooling circuit is multiple times greater than coolant flow through the supercharger air cooling circuit.

3. The cooling system of claim 1, wherein:
one of the ventilation lines includes a throttling restriction to limit flow between the corresponding cooling circuit and the expansion tank.

4. The cooling system of claim 1, wherein:
each ventilation line includes a throttling restriction to limit flow between the corresponding cooling circuit and the expansion tank; and
flow through the second ventilation line is throttled more heavily than flow through the first ventilation line.

5. The cooling system of claim 1, further comprising:
a filler line which communicates a lower fluid collection region of the expansion tank with both cooling circuits.

6. The cooling system of claim 1, wherein:
the supercharger air cooling circuit includes an oil cooler.

7. The cooling system of claim 1, wherein:
the supercharger air cooling circuit includes a supercharger air cooling circuit coolant pump, a supercharger air cooler, and a gearbox oil cooler and the supercharger air cooling circuit heat exchanger connected together in series.

8. The cooling system of claim 1, wherein:
the supercharger air cooling circuit coolant pump is driven electrically.
